(19) United States
(12) Patent Application Publication
(10) Pub. No.: US 2025/0334230 A1
(43) Pub. Date: Oct. 30, 2025

(54) CRYOSTAT, AND METHOD FOR COOLING A CRYOSTAT

(71) Applicant: Bluefors Oy, Helsinki (FI)

(72) Inventors: Pieter Vorselman, Helsinki (FI); Amir Niknammoghadam, Helsinki (FI)

(73) Assignee: Bluefors Oy, Helsinki (FI)

(21) Appl. No.: 18/847,921

(22) PCT Filed: Apr. 5, 2023
(86) PCT No.: PCT/FI2023/050186

§ 371 Date: Sep. 17, 2024

(30) Foreign Application Priority Data
Apr. 21, 2022 (EP) 22169180.1

(51) Int. Cl. F17C 13/00

(52) U.S. Cl. CPC F17C 13/006

(57) ABSTRACT

A cryostat comprises a vacuum enclosure (101) and, inside said vacuum enclosure, a plurality of nested radiation shields (102, 103). Stages of a cryogen-free cooling system (104) are thermally coupled with and configured to cool respective ones of said plurality of nested radiation shields (102, 103). Inside said vacuum enclosure (101) is a thermally conductive layer (201), at least partly surrounding said plurality of nested radiation shields (102, 103). A compressor-driven refrigerator (202) is thermally coupled with said thermally conductive layer (201) and configured to cool said thermally conductive layer (201).

### FIELD OF THE INVENTION

The invention is generally related to the cooling of cryostats. In particular, the invention is related to structural solutions and refrigeration mechanisms that enable cooling a cryostat efficiently, with reasonable consequences in structural complexity.

### BACKGROUND OF THE INVENTION

Early cryostats were cooled with liquid cryogens, such as liquid nitrogen and liquid helium. Later, mechanical cooling devices such as Stirling cryocoolers, Gifford-McMahon coolers, Pulse Tube Refrigerators (PTRs), and Joule-Thomson coolers have been introduced to implement so-called cryogen-free cooling. If the core part of the cryostat comprises a dilution refrigerator, which only becomes operative at temperatures at and below about 4 K, the required pre-cooling may be made with for example a PTR. In a typical case, the PTR has two cooling stages, of which the first stage is used to achieve a temperature around 50-70 K and the second stage pre-cools the dilution refrigerator to the required 4 K level.

Following the stage-wise structure of the refrigeration system, the cryostat typically comprises temperature stages built as flanges parallel to each other and displaced from each other in the perpendicular direction. A top plate of the cryostat may constitute a room temperature flange, below which are a 50 K flange cooled by the first stage of the PTR, a 4 K flange cooled by the second stage of the PTR, as well as further, consecutively colder flanges down to the target region cooled by the mixing chamber of the dilution refrigerator. Radiation shields, each thermally coupled to the respective temperature stage, form a nested structure in which at least some of the colder temperature stages are surrounded by the radiation shield of the previous, warmer temperature stage. The purpose of the radiation shields is to reduce the heat load to the colder parts inside, by intercepting radiated heat from warmer parts outside and conducting it to the respective part of the cooling system.

The required cooling powers can be roughly estimated for the purpose of example. A typical prior art cryogenic system may have a 50 K radiation shield with an inner volume of about 0.3 m³ and a 4 K radiation shield surrounding the target region (with T<1 K) with an inner volume of about 0.1 m³. In terms of effective surface area, the area of the vacuum can (T≈300 K) may be 3.5 m², and area of the 50 K radiation shield may be 2.6 m². With these values, the heat load caused by radiated heat would be around 35 W on the 50 K shield and about 35 mW on the 4 K shield. This kind of heat loads are quite manageable with the first and second stages respectively of a PTR as known at the time of writing this description.

Problems may arise, though, if the size of the cryostat is scaled up. Assuming a 50 K radiation shield with an inner volume of 1.5 m³ and a 4 K radiation shield with an inner volume of 0.5 m³, the effective surface area of the surrounding vacuum can may be 10.5 m² and the area of the 50 K radiation shield may be 7.5 m². This may mean a heat load larger than 100 W on the 50 K shield and a heat load approaching 100 mW on the 4 K shield. While two or more PTRs together could handle the increased heat loads, this is an expensive and possibly mechanically complicated solution.

A known way to reduce the heat load from outside to any radiation shield is so-called multi-layer superinsulation. Layers of thermally insulating and radiation-reflecting foil may be assembled around the cold inner parts. This offers an effective way of reducing heat load, but the assembling necessitates quite cumbersome and time-consuming operations, making multi-layer superinsulation an unattractive option in cases where relatively frequent general access to the inside is needed. Additionally, air may get trapped between layers of the superinsulating material, making it more complicated to achieve the required vacuum conditions.

### SUMMARY

It is an objective to present a cryostat and a method for cooling a cryostat that solve the problem of larger heat loads in an advantageous and technically straightforward way. Another objective is to ensure that the solution is scalable towards even larger cryostats. A further objective is to solve the problem of increased heat loads without sacrificing reliability in operation. A yet further objective is to combine effective cooling with ease of access, partial or complete disassembly, and servicing of the cryostat.

These and further advantageous objectives are achieved by providing a conventionally cooled inner lining inside the room-temperature outer walls of the cryostat.

According to a first aspect, there is provided a cryostat that comprises a vacuum enclosure and—inside said vacuum enclosure—a plurality of nested radiation shields. Stages of a cryogen-free cooling system are thermally coupled with and configured to cool respective ones of said plurality of nested radiation shields. Inside said vacuum enclosure, at least partly surrounding said plurality of nested radiation shields, is a thermally conductive layer. A compressor-driven refrigerator is thermally coupled with said thermally conductive layer and configured to cool said thermally conductive layer.

According to an embodiment, said compressor-driven refrigerator is configured to cool said thermally conductive layer to a temperature between 173 K and 273 K. This involves at least the advantage of significantly reducing the radiated heat load on the nested radiation shields, while simultaneously allowing a relatively simple cooling apparatus to be used.

According to an embodiment, at least a part of said thermally conductive layer is attached to and mechanically supported by the vacuum enclosure. This involves at least the advantage that relatively simple structures are sufficient to mechanically keep the thermally conductive layer in place.

According to an embodiment, a part of said vacuum enclosure is openable, constituting a door or hatch for giving access to inside the vacuum enclosure. A door part or hatch part of said thermally conductive layer may then be attached to and mechanically supported by the openable part of the vacuum enclosure. This involves at least the advantage that the openable part of the vacuum enclosure does not make the structure and implementation of the thermally conductive layer more complicated than necessary.

According to an embodiment, the thermally conductive layer comprises a thermal coupling gasket for thermally coupling said door or hatch part to the rest of the thermally conductive layer when the openable part of the vacuum enclosure is closed. This involves at least the advantage that the compressor-driven refrigerator only needs to make a thermally conductive coupling to one part or a small number of parts of the thermally conductive layer.

According to an embodiment, said compressor-driven refrigerator is a first compressor-driven refrigerator thermally coupled with that portion of said thermally conductive layer that remains within the vacuum enclosure when said openable part of the vacuum enclosure is opened. The cryostat may then comprise a second compressor-driven refrigerator thermally coupled with the door or hatch part. This involves at least the advantage that the openable part of the vacuum chamber does not necessitate providing thermally conductive couplings between parts of the thermally conductive layer that are mechanically separate from each other.

According to an embodiment, the thermally conductive layer has an opening for allowing a plurality of wired connections between respective feedthroughs in the vacuum enclosure and the plurality of nested radiation shields to go through. This involves at least the advantage that the structure and implementation of wired connections may remain relatively simple despite the presence of the thermally conductive layer.

According to an embodiment, the vacuum enclosure consists of two or more modules, each with at least one opening on a surface thereof for interconnecting with the other modules. Said thermally conductive layer may then consist of module-specific portions, each such portion covering at least a part of the inner walls of the respective module. This involves at least the advantage that the principle of reducing radiated heat load to the inner parts of the cryostat may be easily scaled to even very large modular cryostat systems.

According to an embodiment, the cryostat comprises as many compressor-driven refrigerators as there are modules, each compressor-driven refrigerator being thermally coupled with the thermally conductive layer of the respective module. This involves at least the advantage that the principle of reducing radiated heat load to the inner parts of the cryostat may be easily scaled to even very large modular cryostat systems.

According to a second aspect, there is provided a method for cooling a cryostat. The method comprises using stages of a cryogen-free cooling system to cool respective ones of a plurality of nested radiation shields inside a vacuum enclosure of the cryostat and using a compressor-driven refrigerator to cool a thermally conductive layer that at least partly surrounds said plurality of nested radiation shields inside said vacuum enclosure.

According to an embodiment, said use of said compressor-driven refrigerator comprises cooling said thermally conductive layer to an operating temperature between 173 K and 273 K. This involves at least the advantage of significantly reducing the radiated heat load on the nested radiation shields, while simultaneously allowing a relatively simple cooling apparatus to be used.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a cryostat with cryogenfree cooling according to known technology,

FIG. 2 illustrates a cryostat according to an embodiment,

FIG. 3 illustrates a cryostat according to an embodiment, and

FIG. 4 illustrates parts of a cryostat according to an embodiment.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

For the purposes of the following description, it is advantageous to refer to a commonly accepted definition of cryogenic refrigeration. The 13th IIR International Congress of Refrigeration, held in Washington DC in 1971, endorsed a universal definition of “cryogenics” and “cryogenic” by accepting a threshold of 120 K (or −153° C.) to distinguish these terms from conventional refrigeration. Refrigerating devices capable of achieving temperatures that are colder than their surrounding environment but not colder than 120 K may be generally referred to as non-cryogenic coolers. The term should not be confused with cryogen-free cooling systems. The latter refers to cryogenic coolers not directly dependent on the consumption of liquid cryogens, such as Stirling cryocoolers, Gifford-McMahon coolers, Pulse Tube Refrigerators (PTRs), Joule-Thomson coolers, and the like. The operation of non-cryogenic coolers is typically based on closed circulation of liquid refrigerant, such as tetrafluoroethane, isobutane, or the like, through compression and condensation followed by subsequent expansion and evaporation. Consequently, most non-cryogenic coolers may also be called compressor-driven refrigerators.

A non-cryogenic cooler of the kind referred to above may also be characterised by the boiling point of the refrigerant it uses. While this may lead to some overlap with the temperature values mentioned above, for the skilled person it is nevertheless clear that a non-cryogenic cooler, based on closed circulation of liquid refrigerant through compression and condensation followed by subsequent expansion and evaporation, is not a cryogenic cooler. The boiling point of the refrigerant used may be higher than that of nitrogen (77 K), or at least 112 K (boiling point of methane), or at least 247 K (boiling point of 1,1,1,2-tetrafluoroethane), or at least 261 K (boiling point of isobutane).

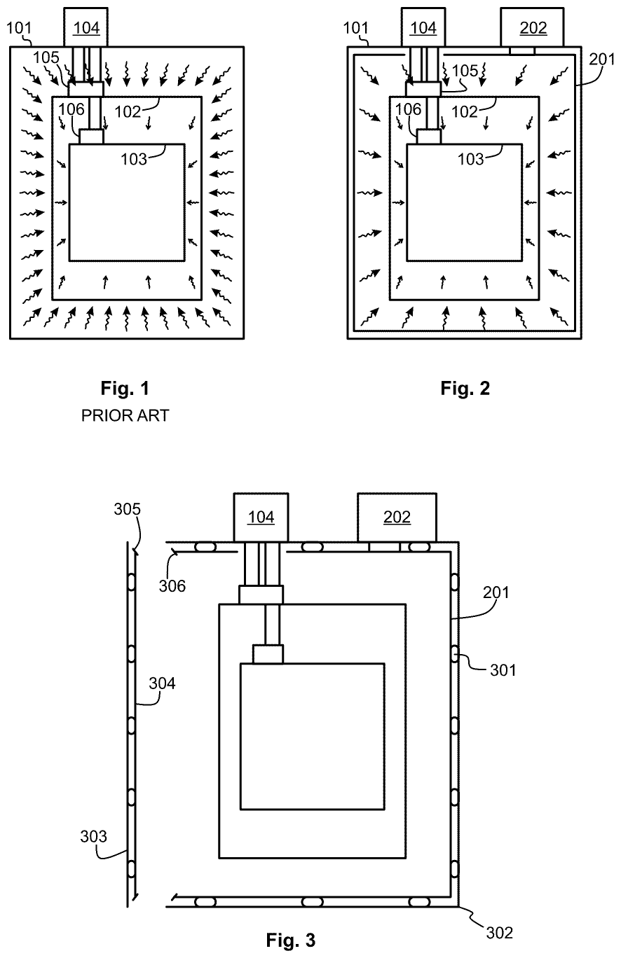

FIG. 1 illustrates schematically a cryostat, an outer part of which is constituted by a vacuum enclosure 101. Inside the vacuum enclosure 101 are a plurality of nested radiation shields, of which a first (outer) radiation shield 102 and a second (inner) radiation shield 103 are shown in FIG. 1. This arrangement of two nested radiation shields is for the purpose of schematic illustration only and does not aim to limit the number of radiation shields in any practical application that could be considered in utilising the solutions described later in this text.

The cryostat of FIG. 1 comprises a cryogen-free cooling system 104, stages of which are thermally coupled with and configured to cool respective ones of the plurality of nested radiation shields. In particular, a first (upper) stage 105 of the cryogen-free cooling system 104 is thermally coupled with the first radiation shield 102 and configured to cool it to a first temperature, which may be for example in the order of magnitude of about 50 to 70 K. A second (lower) stage 106 of the cryogen-free cooling system 104 is thermally coupled with the second radiation shield 103 and configured to cool it to a second temperature, which may be for example in the order of magnitude of about 4 K.

The thermal energy transferred in the form of radiated heat from the vacuum enclosure 101 to the first radiation shield 102 is schematically shown with the radiation arrows pointing inwards between said two structures. Also, the thermal energy transferred in the form of radiated heat from the first radiation shield 102 to the second radiation shield 103 is shown with respective radiation arrows. The thermal load imparted to a colder object by a hotter object is roughly proportional to the fourth power of temperature (as well as to the area through which heat is radiated). Therefore, the relative amount of thermal load experienced by the first radiation shield 102, i.e. the heat radiated inwards by the vacuum enclosure 101, is high compared to that experienced by the second radiation shield 103.

As a comparison, FIG. 2 shows a cryostat that is similar to the cryostat of FIG. 1 concerning the structural parts described above. Additionally, the cryostat of FIG. 2 comprises a thermally conductive layer 201 inside the vacuum enclosure 101, at least partly surrounding the (plurality of) nested radiation shields, of which the radiation shields 102 and 103 constitute an example. A compressor-driven refrigerator 201 is thermally coupled with the thermally conductive layer 201 and configured to cool the thermally conductive layer 201.

The strong dependency on temperature of the thermal load means that even a relatively modest reduction in the temperature of the surface that radiates heat towards the nested radiation shields may reduce the heat load quite significantly. As an example, one may consider the larger cryostat considered in the description of prior art, in which a 50 K radiation shield (corresponding to the first radiation shield 102 in FIGS. 1 and 2) has an inner volume of 1.5 m³ and a 4 K radiation shield has an inner volume of 0.5 m³. As assumed in the description of prior art, the effective surface area of the surrounding vacuum enclosure may be 10.5 m² and the area of the 50 K radiation shield may be 7.5 m². Here it may be further assumed that the thermally conductive layer 201 is close to the inner surface of the vacuum enclosure 102, so that its surface area is essentially the same or only slightly smaller, like 10.3 m². With these exemplary numbers, reducing the temperature of the thermally conductive layer 201 from 300 K to 230 K results in the heat load experienced by the first radiation shield 102 decreasing from about 100 W to about 35 W.

Commercially available compressor-driven refrigerators are known to reach down to at least temperatures between 173 K and 273 K, requiring operating power in the order of magnitude of only some hundreds of watts, or less than 1.5 kW. The thermal coupling between the compressor-driven refrigerator 202 and the thermally conductive layer 201 can be for example similar to what is known from conventional freezers known from domestic appliances.

Reducing the heat load experienced by the first radiation shield 102 means that a single cryogen-free cooling system 104, for example a single PTR, may be sufficient to maintain the first radiation shield 102 cool enough even in a quite large cryostat. Since cryogen-free cooling systems such as PTRs are much more complicated and expensive than compressor-driven refrigerators, the need of a compressor-driven refrigerator and some hundreds of watts more in required operating power means a quite affordable solution, if the other alternative was to provide two PTRs in parallel to cool the first radiation shield 102.

Some further advantageous possibilities are illustrated in FIG. 3. While it may be possible to make the thermally conductive layer 201 self-supporting and/or supported by some general support structure inside the cryostat, an advantageous alternative is to have at least a part of the thermally conductive layer 201 attached to and mechanically supported by the vacuum enclosure 101. In FIG. 3, the thermally conductive layer 201 is a kind of an inner liner of the vacuum enclosure, with thermally insulating supports 301 connecting these two together.

Another possibility shown in FIG. 3 is to make a part 303 of the vacuum enclosure openable, constituting a door or hatch for giving access to inside the vacuum enclosure. In the embodiment of FIG. 3, a body part 302 of the vacuum enclosure defines most walls thereof, and the openable part 303 is essentially a door on one side thereof. A door part or hatch part 304 of the thermally conductive layer is attached to and mechanically supported by the openable part 303 of the vacuum enclosure. Thus, when the openable part 303 of the vacuum enclosure, the thermally conductive layer 201 comes to surround the nested radiation shields also on that side that faces the openable part 303 of the vacuum enclosure.

A simple way to make also the openable part 303 of the vacuum enclosure cool down to the desired temperature is to make the thermally conductive layer 201 comprise a thermal coupling gasket, illustrated with reference designators 305 and 306 in FIG. 3. The thermal coupling gasket may be a structural part of its own, and/or it may comprise edge portions of the thermally conductive layer 201 in the body part 302 and/or the door or hatch part 304 in the openable part 303 of the vacuum enclosure. Such a thermal coupling gasket provides for thermally coupling the door or hatch part 304 to the rest of the thermally conductive layer 201 when the openable part 303 of the vacuum enclosure is closed. The compressor-driven refrigerator 202 then cools them both.

In particular if the openable part 303 of the vacuum enclosure is large, it is possible to refrigerate the door or hatch part 304 on its inside separately. The compressor-driven refrigerator 202 mentioned above may be a first compressor-driven refrigerator and thermally coupled with only that portion of said thermally conductive layer 201 that remains within the vacuum enclosure when said openable part 303 of the vacuum enclosure is opened. The cryostat may then comprise a second compressor-driven refrigerator thermally coupled with the door or hatch part 304.

It is possible to build a larger cryostat in a modular manner, by combining two or more parts like the body part 302 in FIG. 3. If the mechanical interfaces are compatible enough, one may place two such body parts adjacent to each other without their respective openable parts 303 and simply connect the body parts to each other along the edges of their respective openings. Such an arrangement may be described so that the vacuum enclosure consists of two or more modules 302, each with at least one opening on a surface thereof for interconnecting with the other modules. The thermally conductive layer 201 then consists of module-specific portions, each such portion covering at least a part of the inner walls of the respective module 302. One compressor-driven refrigerator 202 may be enough to cool down the whole combination of thermally conductive layers, if the connections are thermally conductive enough. Another possibility is that there are as many compressor-driven refrigerators 202 as there are modules 302, each compressor-driven refrigerator 202 being thermally coupled with the thermally conductive layer 201 of the respective module 302.

Yet another possibility of building a larger, modular cryostat is that there is a separate connection module that goes like a large tube between two adjacent modules, connecting to the edges of their respective openings. Also in such a case, the number of required compressor-driven refrigerators depends on how large the overall structure becomes and how well the partial thermally conductive layers on the insides of the modules conduct heat between each other.

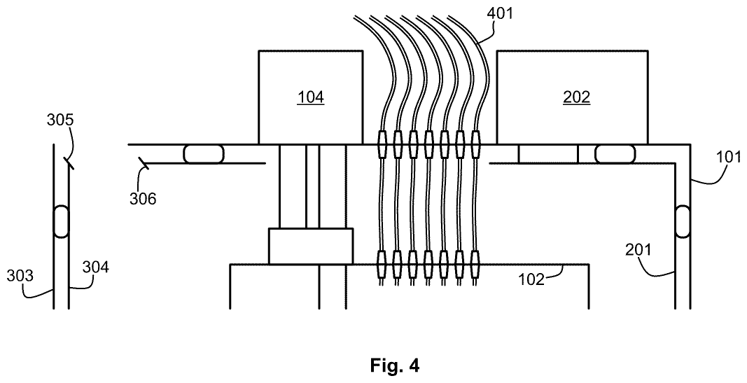

The thermally conductive layer 201 cooled by the compressor driven refrigerator 202 does not need to be continuous. Remembering that its purpose is to reduce the amount of thermal energy that the vacuum enclosure radiates inwards, rather than to completely block it, there may be openings in the thermally conductive layer 201 to make the overall structure of the cryostat mechanically simpler. FIG. 4 shows an example, in which the thermally conductive layer 201 has an opening for allowing a plurality of wired connections 401 between respective feedthroughs in the vacuum enclosure 101 and the plurality of nested radiation shields 102, 103 to go through. There may be hundreds or even thousands of wires between the outside and inside of a large cryostat dedicated to quantum computing, so not having to build separate feedthroughs in the thermally conductive layer and taking them through a common opening instead may significantly help to keep the complicatedness of the overall structure manageable. Additionally, in FIG. 4, parts of the cryogen-free cooling system 104 reach through the same opening in the thermally conductive layer 201.

Every cryostat needs to be opened every now and then, for example for servicing and/or making changes to the inner structures. Before opening, the cryostat must be warmed up. If the cryostat has a thermally conductive layer and a compressor-driven refrigerator like explained above, it may be possible to reverse the cycle so that it warms up the thermally conductive layer instead of cooling it down. This way, the warming up of the whole cryostat may become faster, reducing the idle time that needs to be waited before opening the cryostat becomes possible.

It is obvious to a person skilled in the art that with the advancement of technology, the basic idea of the invention may be implemented in various ways. The invention and its embodiments are thus not limited to the examples described above, instead they may vary within the scope of the claims.

1. A cryostat, comprising:
a vacuum enclosure,
inside said vacuum enclosure a plurality of nested radiation shields, and
a cryogen-free cooling system, stages of which are thermally coupled with and configured to cool respective ones of said plurality of nested radiation shields,
inside said vacuum enclosure, at least partly surrounding said plurality of nested radiation shields, a thermally conductive layer, and
a compressor-driven refrigerator thermally coupled with said thermally conductive layer and configured to cool said thermally conductive layer.

2. A cryostat according to claim 1, wherein said compressor-driven refrigerator is configured to cool said thermally conductive layer to a temperature between 173 K and 273 K.

3. A cryostat according to claim 1, wherein at least a part of said thermally conductive layer is attached to and mechanically supported by the vacuum enclosure.

4. A cryostat according to claim 1, wherein:
a part of said vacuum enclosure is openable, constituting a door or hatch for giving access to inside the vacuum enclosure, and
a door part or hatch part of said thermally conductive layer is attached to and mechanically supported by the openable part of the vacuum enclosure.

5. A cryostat according to claim 4, wherein:
the thermally conductive layer comprises a thermal coupling gasket for thermally coupling said door or hatch part to the rest of the thermally conductive layer when the openable part of the vacuum enclosure is closed.

6. A cryostat according to claim 4, wherein:
said compressor-driven refrigerator is a first compressor-driven refrigerator thermally coupled with that portion of said thermally conductive layer that remains within the vacuum enclosure when said openable part of the vacuum enclosure is opened, and
the cryostat comprises a second compressor-driven refrigerator thermally coupled with the door or hatch part.

7. A cryostat according to claim 1, wherein:
the thermally conductive layer has an opening for allowing a plurality of wired connections between respective feedthroughs in the vacuum enclosure and the plurality of nested radiation shields to go through.

8. A cryostat according to claim 1, wherein:
the vacuum enclosure consists of two or more modules, each with at least one opening on a surface thereof for interconnecting with the other modules, and
said thermally conductive layer consists of module-specific portions, each such portion covering at least a part of the inner walls of the respective module.

9. A cryostat according to claim 8, comprising as many compressor-driven refrigerators as there are modules, each compressor-driven refrigerator being thermally coupled with the thermally conductive layer of the respective module.

10. A method for cooling a cryostat, the method comprising:
using stages of a cryogen-free cooling system to cool respective ones of a plurality of nested radiation shields inside a vacuum enclosure of the cryostat, and
using a compressor-driven refrigerator to cool a thermally conductive layer that at least partly surrounds said plurality of nested radiation shields inside said vacuum enclosure.

11. A method according to claim 10, wherein said use of said compressor-driven refrigerator comprises cooling said thermally conductive layer to an operating temperature between 173 K and 273 K.
